(19) United States
(12) Patent Application Publication
(10) Pub. No.: US 2025/0386826 A1
(43) Pub. Date: Dec. 25, 2025

(54) MATERIAL HAVING ANTIMICROBIAL ACTIVITY AND RELATED PRODUCT PROCESS

(71) Applicant: SASCO INNOVATION S.R.L.S., Napoli (IT)

(72) Inventors: Francesco SAVERIANO, Caserta (IT); Michele BALLETTA, San Feiice a Cancello (IT)

(73) Assignee: SASCO INNOVATION S.R.L.S., Napoli (IT)

(21) Appl. No.: 19/110,421

(22) PCT Filed: Oct. 20, 2023
(86) PCT No.: PCT/IT2023/050234

§ 371 Date: Mar. 10, 2025

(30) Foreign Application Priority Data
Nov. 3, 2022 (IT) 102022000022548

(51) Int. Cl. A01N 59/20; A01N 25/10; A01N 43/36; A01P 1/00

(52) U.S. Cl. CPC A01N 59/20; A01N 25/10; A01N 43/36; A01P 1/00

(57) ABSTRACT

This invention concerns an antimicrobial composite polymer material through a production process that uses a combination of a polymer matrix material such as a thermoplastic elastomer (hereinafter also called TPE) supplemented with the active Povidone-iodine compounds (hereinafter also called PVP-I) and CuAl Carbonate, formed by copper-based nanoparticles embedded in hydrotalcite, to which active additives such as copper oxides CU2O, 30-50 NM, 99% and CUO, 30-50 NM, 99% can be added.

This invention concerns an antimicrobial composite polymer material through a production process that uses a combination of a polymer matrix material such as a thermoplastic elastomer (hereinafter also called TPE) supplemented with the active Povidone-iodine compounds (hereinafter also called PVP-I) and CuAl Carbonate, formed by copper-based nanoparticles embedded in hydrotalcite, to which active additives such as copper oxides CU2O, 30-50 NM, 99% and CUO, 30-50 NM, 99% can be added.

As all industry professionals know, the fundamental difference between antibacterial and antimicrobial substances is the type of microorganisms that they take take root in and act on.

While antibacterial technologies are effective against a wide spectrum of harmful bacteria, antimicrobial technologies minimize the presence of bacteria, molds, fungi and in some cases even viral strains.

Unlike antibacterial agents, antimicrobial substances provide a higher level of protection for the product. The broad-spectrum performance of antimicrobial substances makes them perfect for use in environments where hygiene plays a critical role.

More specifically, the protection provided by antimicrobial materials is activated when a microorganism comes into contact with a surface of the product. In recent years, market interest in these materials has grown considerably. The attention paid to these materials, capable of inhibiting bacterial growth, has increased especially in the healthcare sector, even if their potential for use is the most diverse.

Therefore, the objective and purpose of the invention is to create a polymer material with antimicrobial efficacy that can then be used for manufacturing final products ranging, for example, from clothing, to films rather than coatings, and to the production of products for healthcare use.

These objectives are achieved by means of a composite material, as defined in the following claims, which form an integral and substantial part of this description.

In particular, the manufacturing process of the polymer material basically uses an active matrix identified in a TPE, formed by a class of copolymers or a polymer mixture with thermoplastic and elastomeric properties that have the typical advantages of both plastics and rubbers. Thermoplastic elastomers have a recyclable feature, as they can be printed, extruded and reused like plastic, but they also have the typical elastic properties of rubber. In this invention, thermoplastic elastomers are used in the form of granules.

This active matrix is first of all supplemented with Povidone-iodine (PVP-I), which in this invention is used in powder form, it is a compound obtained by combining the polyvinylpyrrolidone polymer (PVP) with iodine in the form of triiodide ions. The most common use of this active ingredient is to disinfect skin or wounds, for antiseptic for oral treatments and hygiene.

Another additive used is CuAl Carbonate, a porous doublehydroxide (LDH) layer particle that can be suitably functionalized to host the drug, consisting of copper-based nanoparticles embedded in hydrotalcite.

As part of the invention, for the purposes of the production process, the TPE active matrix is used in granules, the Povidone-iodine in powder, and the CuAl carbonate in copper-based nanoparticles embedded in hydrotalcite.

In general, the composite material object of the invention may be preferably a composition comprising of TPE, in the desired amount, Povidone-iodine in a percentage 0.1-1.00%, preferably 0.5%, and CuAl Carbonate in a percentage between 0.1-2.00%, preferably 1%, compared to the amount of TPE used.

To prepare the new material, the TPE is first fed and mixed, in granules, in the desired quantity, in a batch mixer at a temperature of 180° at a speed of 50 85 rpm for 4 minutes. Subsequently, when the mixing chamber is opened, the Povidone-iodine is first fed in a percentage between 0.1-1.00%, preferably 0.5%, with respect to the weight of the TPE, and then mixed for 7 minutes at a speed of 50 rpm and at a temperature 90 of 180°; and then the CuAl Carbonate is fed in a percentage between 0.1-2.00%, preferably 1%, with respect to weight of the TPE, mixing everything for an additional 7 minutes at a speed of 50 rpm and at a temperature of 180°.

95 Afterwards the mixed mass collected by the mixer is pressed at T=180° C., using a Colin press at a pressure of P=50 bar, for t=3 minutes, until a film is obtained.

### EXAMPLE

To prepare the material, the TPE (50 grams) is first fed and mixed, in granules, in a discontinuous mixer at a temperature of 180° at a speed of 50 rpm for 4 minutes. Subsequently, when the mixing chamber is opened, the Povidone-iodine is first fed in percentage of 0.5%, and then the CuAl Carbonate is added in a percentage of 1%, with respect to weight of the TPE, mixing for 7 minutes at a speed of 50 rpm and at a temperature of 180°.

Afterwards the mixed mass collected by the mixer is pressed at T=180° C., using a Colin press at a pressure of P=50 bar, for t=3 minutes.

To evaluate the antimicrobial efficacy of the invention, the following bacterial strains were used: Escherichia coli (ATCC 13762) and Staphylococcus aureus (ATCC 6538), cultivated at 37° C. in Tryptic Soy Broth (TSB). More specifically, a colony of each bacterial strain was taken from a master plate using a loop with a platinum eyelet and subsequently diluted in 10 mL of TSB. The two cultures were incubated overnight to allow the bacteria to reach the exponential growth phase.

The testing of the antibacterial efficacy of the material produced was conducted in accordance with ISO 22196 (2007). Square samples (50 mm×50 mm) of the materials treated were prepared.

Before the start of the test, all samples were cleaned/disinfected through immersion in 70% ethanol, placed in Petri dishes and then inoculated with bacterial cells (0.4 mL of suspension, with a final concentration of 6×10 5 cells/mL) taken from the overnight cultures and then diluted with Nutrient Broth (1/500). The inoculated samples were covered with a disinfected polyethylene cover (40 mm×40 mm), gently pressed to distribute the bacterial cells up to the edges, and incubated at 37° C. for 24 hours with a relative humidity of no less than 908. After the incubation time, each sample was washed by adding 10 mL of SCDLP (Soybean Casein Digest broth with Lecithin and Polyoxyethylene sorbitan monooleate). Starting with the SCDLP solution, serial dilutions were made by a factor of 10 in a phosphate buffered saline solution, and then 1 mL of each dilution and 1 mL of SCDLP recovered from the sample were placed in duplicate in Petri dishes. Finally, 15 mL of Plate Count Agar (PCA) medium was poured into each Petri dish by performing inclusion plating. The Petri dishes were flipped over and incubated at 37±1° C. for 24-48 hours.

After incubation, the number of live bacterial cells was determined for each sample as follows: N=(100×C×D×V)/A, where N is the number of live bacterial cells recovered per 2 cm of sample, C is the average count of colonies in the duplicate plates, D is the dilution factor for the plates counted, V is the volume (mL) of SCDLP added to the sample, A is the surface area in mm², of the covering film. Starting from the value of N, the logarithmic value of the number of live bacterial cells recovered (log N) was calculated and the antibacterial activity was expressed as an R value (Ghamrawi et al., 2017):

$$R = Ut - At$$

where Ut is the average of the logarithm of the number of viable bacteria (cells/cm 2) recovered from untreated samples after 24 hours; At is the average of the common logarithm of the number of viable bacteria (cells/cm 2) recovered from treated samples after 24 hours.

To identify the antibacterial efficacy of the samples, the classification by Scuri and coauthors (2019) was used, namely:
R≤0.5 log (reduction in microbial growth<68.4%)=no antibacterial activity;
R 0.5-1 log (reduction in microbial growth<68.4% to <90%)=slight antibacterial activity;
R>1 to ≤2 log (reduction in microbial growth 90% to<99%)=medium antibacterial activity;
R 2 to <3 log (reduction in microbial growth 99% to <99.9%)=good antibacterial activity;
R>3 (reduction in microbial growth>99.9%)=excellent antibacterial activity.

The results obtained are shown in the following tables:

| | | S. aureus (R- |
|---|---|---|
| Samples | E. coli (R value) | value) |
| TPE/05PVP/1HT116 | 5.80 ± 0.45 | 5.06 ± 0.05 |

The R-value expresses the capacity for the logarithmic reduction of the bacterial load in contact with the sample after a 24-hour contact. The samples with the TPE/Povidone-iodine/1HT116 mixture showed an almost unchanged antibacterial capacity of the material against both the E. coli and S. aureus strains.

The data obtained from the tests carried out on materials stored at room temperature and humidity for more than 100 days, show that the material covered by this patent retains the capacity to reduce bacterial load against E. coli (R=4.27) and good activity against S. aureus (R=2.6).

Furthermore, the material thus created has been found to perform well in thermogravimetric, thermal and chemical analyses, as well as in terms of mechanical properties.

Finally, it was determined that other active additives may be added to the components used in the production process of the new material, such as copper oxides CU2O, 30-50 NM, 99% and CUO, 30-50 NM, 99% in percentages ranging from 1-3%, preferably 1.5% of the weight of the TPE, which can give the material even more antimicrobial characteristics.

This invention and its functionalities have been described by way of illustration, not limited to the same, and it must therefore be understood that changes and/or amendments to the procedure(s) may be carried out without falling outside the relevant scope of protection.

1. Material having antimicrobial activity, comprising:
a compound consisting of a thermoplastic elastomer, Povidone-iodine, in a percentage between 0.1-1.00%, preferably 0.5%, with respect to the weight of the thermoplastic elastomer and CuAl Carbonate in a percentage between 0.1-2.00%, preferably 1%, with respect to the weight of the thermoplastic elastomer in which to the thermoplastic elastomer, to the Povidone-iodine, in a percentage between 0.1-1.00%, preferably 0.5% with respect to the weight of the thermoplastic elastomer, and to which
CuAl Carbonate in a percentage between 0.1-2.00%, preferably 1%, with respect to the weight of the thermoplastic elastomer, are added, cumulatively or separately, active additives such as copper oxides CU20, 30-50 NM, 99% and CUO, 30-50 NM, 99% in percentages ranging from 1-3%, preferably 1.5%, of the weight of the thermoplastic elastomer.

2. Production process of material having antimicrobial activity, according to claim 2, in which, in a first embodiment, in a discontinuous mixer the thermoplastic elastomer is mixed, in granules, in the desired quantity, at a temperature of 180° at a speed of 50 rpm for 4 minutes;
the Povidone-iodine is first fed and then mixed in a percentage between 0.1-1.00%, preferably 0.5% of the weight of the thermoplastic elastomer for 7 minutes at a speed of 50 rpm and at a temperature of 180; and
the CuAl Carbonate is fed in a percentage between 0.1-2.00%, preferably 1%, of the weight of the thermoplastic elastomer, mixing all for a further 7 minutes at a speed of 50 rpm and at a temperature of 180°.

3. Production process of material having antimicrobial activity, according to claim 2, in which, in a second embodiment, in a discontinuous mixer the thermoplastic elastomer is mixed, in granules, in the desired quantity, at a temperature of 180° at a speed of 50 rpm for 4 minutes;
Povidone-iodine is fed and mixed in a percentage between 0.1-1.00%, preferably 0.5% of the weight of the thermoplastic elastomer for 7 minutes at a speed of 50 rpm and at a temperature of 180°; and
CuAl Carbonate is fed in a percentage between 0.1-2.00% preferably 1%, of the weight of the thermoplastic elastomer, and then, jointly or separately, the active additives such as copper oxides CU2O, 30-50 NM, 99% and CUO, 30-50 NM, 99% in percentages ranging from 1-3%, preferably 1.5% of the weight of the thermoplastic elastomer, mixing the whole for a further 7 minutes at a speed of 50 rpm and at a temperature of 180°.

4. The production process of material having antimicrobial activity, according to claim 2, in which the mixed mass collected by the discontinuous mixer is pressed at T=180° C., using a Colin press at a pressure P=50 bar, for a time of t=3 minutes, until a film is obtained.

5. The production process of material having antimicrobial activity, according to claim 3 in which the mixed mass collected by the discontinuous mixer is pressed at T=180° C., using a Colin press at a pressure P=50 bar, for a time of t=3 minutes, until a film is obtained.
